(19) United States
(12) Patent Application Publication
(10) Pub. No.: US 2017/0039076 A1
(43) Pub. Date: Feb. 9, 2017

(54) ADJUSTING TAP POSITION ON TOUCH SCREEN

(71) Applicant: Empire Technology Development LLC, Wilmington, DE (US)

(72) Inventor: Shuichi KURABAYASHI, Fujisawa-shi, Kanagawa (JP)

(73) Assignee: Empire Technology Development LLC, Wilmington, DE (US)

(21) Appl. No.: 15/303,841

(22) PCT Filed: Apr. 30, 2014
(86) PCT No.: PCT/US14/36091

§ 371 Date: Oct. 13, 2016

(51) Int. Cl. G06F 9/44; G06F 3/0488

(52) U.S. Cl. CPC G06F 9/4443; G06F 3/04883

(57) ABSTRACT

Technologies are generally described for adjusting a tap position on a display screen of an application running on an electronic device. Example devices/systems described herein may use one or more of a probability calculator, a tap detector, a tap position adjustor and/or an area map database (DB). In various examples, an electronic device may determine tap probabilities for one or more user interface (UI) components of the application by the probability calculator. The tap detector may detect a user's tap position on at least one of the UI components. Further, the tap position adjustor may adjust the tap position based on the tap probabilities. An area map may be generated to define clickable areas on the display screen corresponding to the one or more UI components, and may be stored in the area map DB which may be shared with some other electronic devices through a cloud system.

### BACKGROUND

Unless otherwise indicated herein, the approaches described in this section are not prior art to the claims in this application and are not admitted to be prior art by inclusion in this section.

Recently, the resolutions of touch display screens provided in mobile devices such as smartphones and tablet computers have been increasing. Thus, user interface (UI) components on the display screens may be displayed in relatively small sizes, for which a user's tap or touch operations may result in selection of an unintended UI component. For example, UI components such as menu items and icons may be collectively rendered in a specific area on the screens for the convenience of user's operations. However, this arrangement of the UI components may often make it difficult for the user to correctly tap intended UI components with his/her finger.

To resolve the above problems, the UI components may be displayed in an enlarged size as needed, which may decrease the total amount of information that can be displayed on the screens. For example, SVG (scalable vector graphics) may be employed to render UI components that can be enlarged or reduced according to various display resolutions. However, it may not be practical to apply such vector-based graphics to all existing applications and webpages. Moreover, frequent changes in the display resolutions may make it more difficult for application developers to design UI components according to all possible display resolutions.

Further, incorrect tap operations on the UI components for web-based applications may require the user to cancel the selection of the tapped UI component and re-tap his/her finger on the originally intended UI component. However, this may result in unnecessarily increasing use of computing power and network traffic on the Internet. According to recent statistics provided by the hypertext transfer protocol (HTTP) archive, data transmission of about 50 GBytes on the Internet may be saved if incorrect tap operations on mobile devices could be reduced by 5% per day.

### SUMMARY

Technologies generally described herein relate to adjusting a tap position on a touch display screen of an electronic device.

Various example apparatus configured to adjust a tap position on a display screen of an application described herein may include one or more of a probability calculator, a tap detector and/or a tap position adjustor. The probability calculator may be configured to determine tap probabilities for one or more user interface (UI) components of the application. The tap detector may be configured to detect a user's tap position on at least one of the UI components. The tap position adjustor may be configured to adjust the tap position based on the determined tap probabilities.

In some examples, an electronic device is described such as any example electronic device described herein that may be adapted to adjust a tap position on a display screen of an application running on the electronic device. Example electronic devices may include one or more of a probability calculator, a tap detector, a tap position adjustor and/or an area map database (DB). The probability calculator may be configured to determine tap probabilities for one or more user interface (UI) components of the application. The tap detector may be coupled to the probability calculator and configured to detect a user's tap position on at least one of the UI components. The tap position adjustor may be coupled to the probability calculator and to the tap detector and configured to adjust the tap position based on the determined tap probabilities. The area map DB may be configured to store an area map that defines clickable areas on the display screen corresponding to the one or more UI components.

In some examples, methods to adjust a tap position on a display screen of an application in an electronic device are described. Example methods may include determining tap probabilities for one or more user interface (UI) components of the application. A user's tap position on at least one of the UI components may be detected. Further, the tap position may be adjusted based on the determined tap probabilities.

In some examples, a computer-readable storage medium is described that may be adapted to store a program operable by an electronic device to adjust a tap position on a display screen of an application. The processor may include various features as further described herein. The program may include one or more instructions for determining tap probabilities for one or more UI components of the application, detecting a user's tap position on at least one of the UI components, and adjusting the tap position based on the detected tap probabilities.

In some examples, a system is described such as any example system described herein that may be adapted to adjust a tap position on a display screen of an electronic device. Example systems may include one or more of a probability calculator, a tap detector, a tap position adjustor and/or an area map database (DB). The probability calculator may be configured to determine a tap probability for one or more user interface (UI) components presented on the display screen. The tap detector may be coupled to the probability calculator and configured to detect a tap position on at least one of the UI components. The tap position adjustor may be coupled to the probability calculator and to the tap detector and configured to adjust the tap position based on the determined tap probability and based on the detected tap position. The area map database (DB) may be coupled to the probability calculator and configured to store an area map that defines clickable areas on the display screen corresponding to the one or more UI components. The area map DB is further configured to store tap probabilities in association with the clickable areas defined by the area map.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a diagram of an example system configured to adjust a tap position on a display screen of an application running on an electronic device;

FIG. 2 shows a block diagram of an example electronic device configured to adjust a tap position on a display screen of an application;

FIG. 3 shows an example operation of generating an area map that defines clickable areas on a display screen corresponding to one or more UI components of an application;

FIG. 4 shows an example operation of detecting a user's tap position on UI components and adjusting the tap position based on tap probabilities for the UI components;

FIG. 5 illustrates an example flow diagram of a method adapted to adjust a tap position on a display screen of an application in an electronic device;

FIG. 6 shows a block diagram illustrating an example computing system that can be configured to implement method to adjust a tap position on a display screen of an application in an electronic device; and

FIG. 7 illustrates computer program products that can be utilized to adjust a tap position on a display screen of an application in an electronic device, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices and computer program products related to adjusting a tap position on a touch display screen of an electronic device.

Briefly stated, technologies are generally described for adjusting a tap position on a display screen of an application running on an electronic device. Example devices/systems described herein may use one or more of a probability calculator, a tap detector, a tap position adjustor and/or an area map database (DB). In various examples, an electronic device such as a smartphone or a tablet computer is described, where the device may be configured to adjust a tap position on a display screen of an application based on tap probabilities for one or more user interface (UI) components of the application. The probability calculator of the device may be configured to determine the tap probabilities for the UI components of the application. Further, the tap detector may detect a user's tap position on at least one of the UI components. Further, the tap position adjustor may adjust the tap position based on the tap probabilities. An area map may be generated to define clickable areas on the display screen corresponding to the one or more UI components, and may be stored in the area map DB which may be shared and synchronized with some other electronic devices through a cloud system.

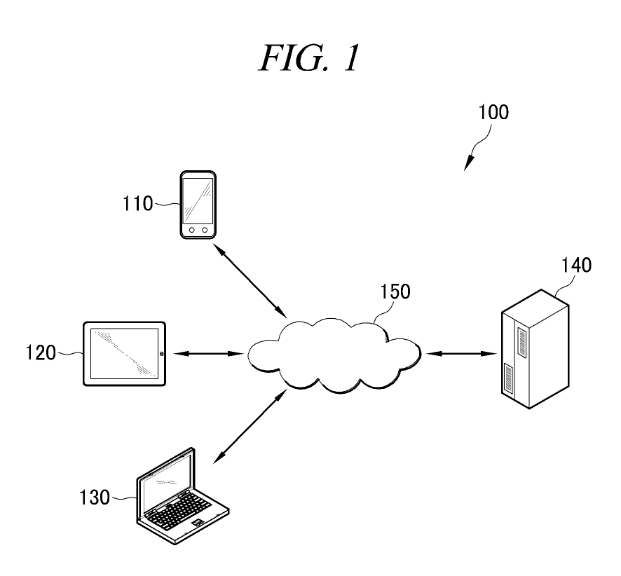

FIG. 1 shows a diagram of an example system configured to adjust a tap position on a display screen of an application running on an electronic device, arranged in accordance with at least some embodiments described herein. As depicted, a system 100 may include one or more electronic devices such as a smart phone 110, a tablet computer 120, a laptop computer 130, or some other electronic device. System 100 may further include a server, such as a cloud server 140, coupled to electronic devices 110 to 130 through a network 150 such as, for example, the Internet, a wireless network, a cellular network, a wide area network (WAN), a metropolitan area network (MAN), a local area network (LAN), a campus area network (CAN), a virtual private network (VPN), etc. Each of electronic devices 110 to 130 may be any other suitable type of electronic or computing device, such as a wearable computer, a car navigation device, a smart TV, etc., which may be equipped with wired or wireless communication capabilities. Also, each electronic device 110 to 130 may include a touch display unit configured to receive a user's tap or touch input on one or more user interface (UI) components such as clickable buttons, icons, and any other suitable type of graphical object or text. In some embodiments, cloud server 140 may store or otherwise have access to an area map database (DB) that may be updated, accessed or shared by electronic devices 110 to 130 through network 150. The area map DB may be configured to store one or more area maps for electronic devices 110 to 130 that define clickable areas on the display screen corresponding to the UI components, which will be described later in more detail below.

In operation, each of electronic devices 110 to 130 may calculate or determine tap probabilities for one or more UI components on a display screen of an application that may be running on the electronic device. In some embodiments, the application may be a web browser or any other suitable type of computer program that is designed to run on electronic devices 110 to 130. More specifically, each of electronic devices 110 to 130 may accumulate or count the frequencies of tap operations and/or tap cancelling/reverting operations performed by a user, and determine the tap probabilities by dividing the frequency of the operations for each UI component by a sum of the frequencies of the operations. Thus, calculated tap probabilities may be associated with a screen state of the application. For example, the screen state of the application may be an identifier that indicates a particular display image (e.g., a display image of a particular web page) or a resource locator for the display image (e.g., an URL associated with the web page). By determining the tap probabilities, each of electronic devices 110 to 130 may obtain information on the positions on the UI components that are frequently tapped by the user in each screen display of the application.

In some embodiments, each of electronic devices 110 to 130 may detect a user's tap position on the UI components of the application and adjust the tap position based on the tap probabilities. For example, when a touch input by the user is made on more than one UI components on the display screen, an UI component that the user originally intended to touch may be estimated based on the tap probabilities associated with the actually touched UI components. The user's tap position may be adjusted according to the estimation of the UI component that the user originally intended to touch. Each of electronic devices 110 to 130 may cancel the adjustment of the tap position in response to detection of the user's input to cancel the adjustment of tap position (e.g., a user's touching on a cancel button). In some embodiments, the above-described function for tap position adjustment may be implemented using a run-time module embedded in the application such as a JavaScript module installed in a web browser.

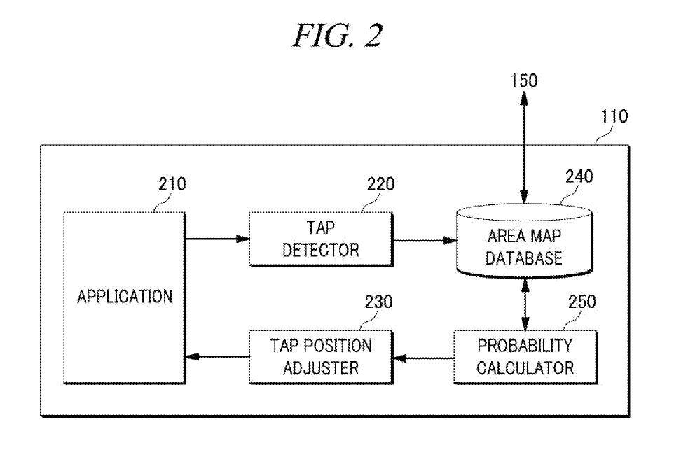

FIG. 2 shows a block diagram of an example electronic device configured to adjust a tap position on a display screen of an application, arranged in accordance with at least some embodiments described herein. As illustrated, an electronic device 110 may include one or more of an application 210, a tap detector 220, a tap position adjuster 230, an area map database (DB) 240 and/or a probability calculator 250 operatively coupled to each other or otherwise in communication with each other. In some embodiments, at least some of these elements may be implemented in hardware, software, or a combination of hardware and software. In some embodiments, electronic device 110 may be any suitable type of electronic or computing device, such as a smartphone, a tablet computer, etc., which is equipped with wired or wireless communication capabilities and a touch display unit configured to receive a user's touch input on one or more user interface (UI) components such as clickable buttons, icons, and any other suitable type of graphical object or text. The configuration of electronic device 110 as illustrated in FIG. 2 may be implemented in any of electronic devices 110 to 130 shown in FIG. 1.

In some embodiments, application 210 may be computer program or an instance of the program running in electronic device 110 that causes a processor (not shown) to perform tasks or instructions input from a user. For example, application 210 may include a mobile or web application, which may be programmed with hypertext markup language (HTML), JavaScript and/or any other suitable type of web-native technologies and which may typically run on the processor to be online and/or execute a web browser. In some other examples, application 210 may include a more traditional native application, which may be programmed with a programming language that is available for electronic device 110.

In some embodiments, electronic device 110 or the processor of electronic device 100 may generate an area map that defines clickable areas on a display screen corresponding to one or more UI components of application 210. For example, when application 210 is executed to display a web page on the display screen, electronic device 110 may determine areas on the display screen that can be tapped or clicked, and generate an area map defining the positional relationship among the clickable areas (e.g., clickable UI components such as buttons, icons, text, etc.). The generated area map may be stored in area map DB 240. In some embodiments, the area map may be stored in area map DB 240 in association with a screen state ID of application 210, e.g., a URL of the associated web page. When another web page is displayed on the display screen, e.g., due to a transition of the previous web page to a new web page by a user input, electronic device 110 may generate a new area map in a similar manner as described above and store the area map in area map DB 240. Again the new area map may be stored in area map DB 240 in association with a new screen state ID of application 210.

In some embodiments, to render an image or document including the UI components by application 210 (e.g., a HTML web page rendered by a web browser), application 210 may use an internal model for representing and interacting with objects in the document such as a document object model (DOM) for representing objects in HTML, extendible (XHTML) and extendible markup language (XML) and/or other type of documents. In this case, elements or nodes of the document may be organized in a tree structure, which may be referred to as a DOM tree. For example, when an HTML page is rendered in application 210, application 210 may download the HTML into a location memory and automatically parse it to a DOM tree for displaying on the display screen. Further, the DOM may be used by application 210 (e.g., JavaScript embedded in a web browser) to detect the state transition of application 210 in HTML pages. Accordingly, in case of DOM, the area map may be generated by calculating the positions of DOM nodes corresponding to the clickable areas in a DOM tree, which may be generated independently from the size, resolution and/or orientation of the display screen.

In some embodiments, probability calculator 250 may be configured to determine tap probabilities for one or more UI components of application 210. More specifically, probability calculator 250 may record frequencies of taps on the UI components and determine the tap probabilities by division of the frequency of taps for each UI component by a sum of the frequencies of taps. Additionally, probability calculator 250 may be configured to reflect cancellation of a tap operation on any of the UI components in determining the tap probabilities. For example, when a user inputs a revert/cancel operation, probability calculator 250 may deduct a count of the previous tap on a certain UI component from the sum of the frequencies of taps, such that incorrect tap operation will not be reflected in determining the tap probabilities.

For example, each time a user taps on certain UI components of application 210 (e.g., anchor tags, input tags, and DOM elements that detect click events in a web page), probability calculator 250 may measure the tap frequencies of the individual UI components. If it is assumed that the i-th UI component of application 210 is denoted by Eᵢ, the tap probability p(e) of a specific UI component e can be defined by the following equation:

$$p ( e ) = \frac{tap ( e )}{{\sum }_{i = 0}^{n} tap ( {E}_{i} )}$$

where n denotes the total number of UI components in application 210, tap(Eᵢ) denotes the number of times that the UI component Eᵢ has been tapped, tap(e) denotes the number of times that the UI component e has been tapped. As discussed earlier, the above-defined probabilities may not depend on the physical dimension of the display screen (e.g., screen size, resolution, orientation, etc.) if the UI components are identified based on their positions in a DOM tree instead of their physical positions (e.g., x and y coordinates) on the display screen.

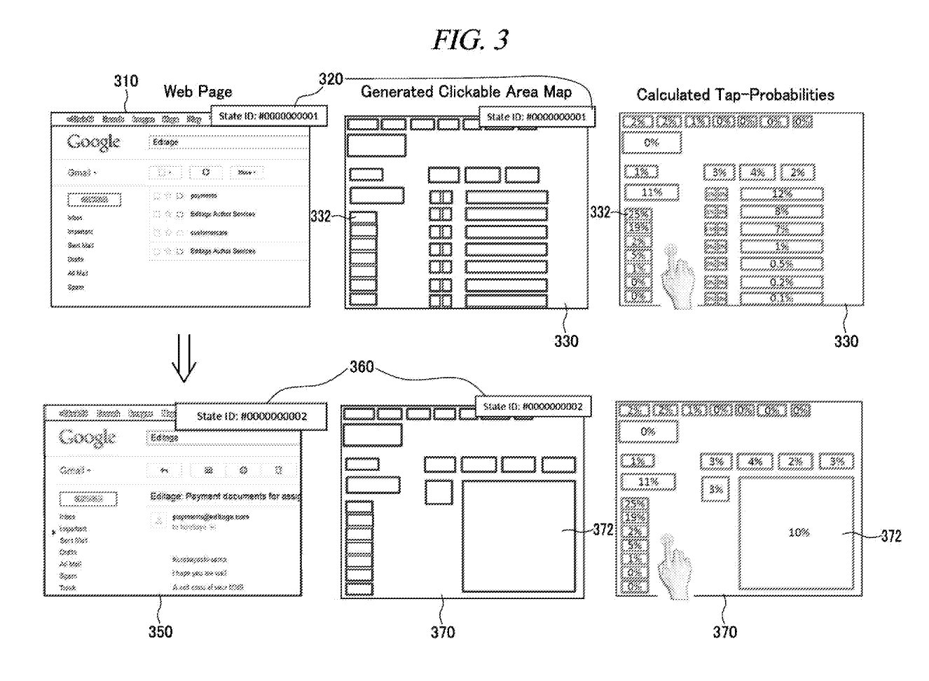

FIG. 3 shows an example operation of generating an area map that defines clickable areas on a display screen corresponding to one or more UI components of an application, arranged in accordance with at least some embodiments described herein. As depicted, when application 210 is executed to display a web page 310 on a display screen of electronic device 110, web page 310 may be associated with a screen state ID 320. An area map 330 may be then generated to define the positional relationship among clickable areas or UI components rendered in web page 310. For example, area map 330 may be determined by calculating the positions of DOM nodes corresponding to the clickable areas in a DOM tree, which may be generated independently from the size and/or orientation of the display screen. Then, probability calculator 250 may determine tap probabilities for the clickable areas, e.g., by recording frequencies of taps on the areas and determine the tap probabilities by division of the frequency of taps for each clickable area by a sum of the frequencies of taps. For example, a tap probability of 25% (or 0.25) may be determined and assigned for a clickable area 332 as illustrated in FIG. 3.

If another web page 350 is displayed on the display screen, e.g., due to a user's input that causes a change in a DOM of the web page, electronic device 110 may generate a new area map 370 in a similar manner as described above. Again, web page 350 and area map 370 may be associated with a new screen state ID 360. Then, probability calculator 250 may determine tap probabilities for the clickable areas in area map 370, e.g., by recording frequencies of taps on the areas and determine the tap probabilities by division of the frequency of taps for each clickable area by a sum of the frequencies of taps. For example, a tap probability of 10% (or 0.10) may be determined for a clickable area 372 as illustrated in FIG. 3.

Referring back to FIG. 2, tap detector 220 may be configured to detect a user's tap position on one or more of the UI components of application 210. Further, tap position adjustor 230 may adjust the tap position based on the tap probabilities for the UI components. More specifically, tap detector 220 may detect a first position at which the user starts a touch on the display screen and detect a second position at which the user ends the touch on the display screen. Further, tap detector 220 may determine a center of gravity for the first and second positions as the user's tap position.

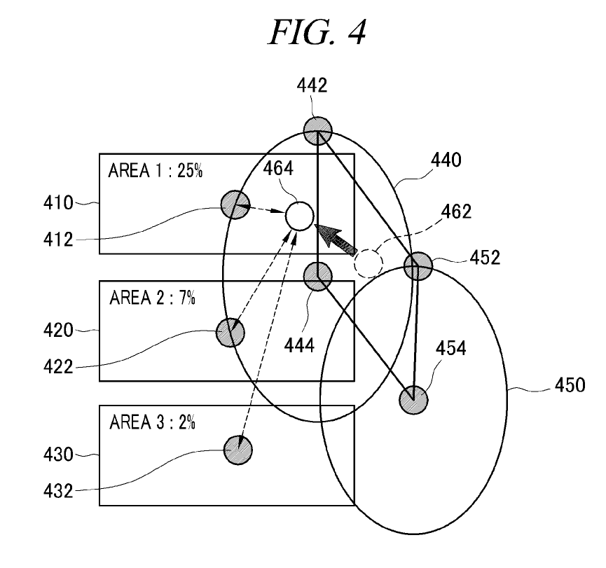

FIG. 4 shows an example operation of detecting a user's tap position on UI components and adjusting the tap position based on tap probabilities for the UI components. As depicted, when a user taps on the display screen with a finger, a first position or area 440 at which the finger touches the screen may differ from a second position or area 450 at which the finger detaches from the display screen. If only either one of first and second positions 440 and 450 is considered as the user's tap position, it often does not correctly reflect the user's intended touch position. Accordingly, the center of gravity of first and second positions 440 and 450 may be calculated and used as a basis for estimating the user's intended touch position.

In some embodiments, tap detector 220 may calculate an original tap gravity point 462 based on first and second positions 440 and 450. As illustrated in FIG. 4, original tap gravity point 462 may be a center of gravity of a rectangular area composed by an upper point 442 and a center point 444 of first position 440, and a upper point 452 and a center point 454 of second position 450.

In some embodiments, tap position adjustor 230 may identify clickable areas 410, 420 and 430 in an area map for the current display screen that overlap at least part with first and second positions 440 and 450. Also, tap position adjustor 230 may calculate distance vectors \vec{v}ᵢ between centers of identified clickable areas 410 to 430 and original tap gravity point 462. Tap position adjustor 220 may further calculate a center of gravity \vec{G} of distance vectors \vec{v}ᵢ, where distance vectors \vec{v}ᵢ may be weighted by the tap probabilities for identified clickable areas 410 to 430. Tap position adjustor 230 may adjust the user's tap position to the center of gravity \vec{G} of distance vectors \vec{v}ᵢ.

In some embodiments, tap position adjustor 230 may be further configured to cancel the adjustment of the user's tap position in response to detection of a user's input to cancel the adjustment of the tap position. For example, in case the user's input subsequent to the adjustment of the tap position indicates that the user wants to revert or cancel the adjustment of the tap position, it may be determined that the adjustment of the tap position is incorrect and/or that any subsequent tap adjustment operation is suspended for a predetermined period of time.

As described above, area map DB 240 may be configured to store one or more area maps, which defines clickable areas (or UI components) on a display screen of electronic device 110, in association with screen state IDs of application 210. Further, area map DB 240 may store the tap probabilities for the clickable areas. In some embodiments, the area maps may be uploaded from area map DB 240 to a cloud server, such as cloud server 140, such that the uploaded area maps can be shared and synchronized among electronic device 110 and any other electronic devices that are possessed and used by the same user. In this manner, all the electronic devices possessed by the same user can update and utilize the user's tapping characteristics for the adjustment of the user's tap positions on display screens of the electronic devices.

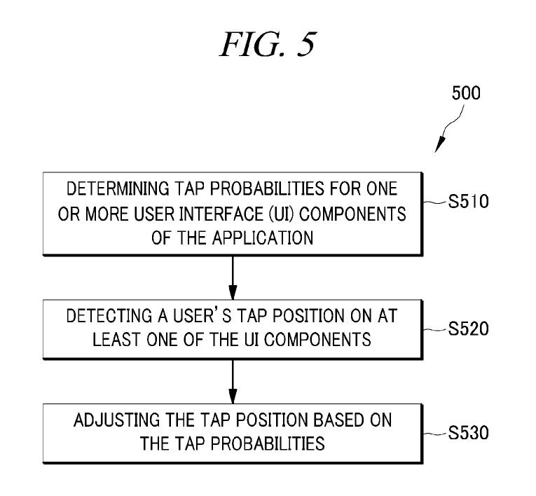

FIG. 5 illustrates an example flow diagram of a method adapted to adjust a tap position on a display screen of an application in an electronic device, arranged in accordance with at least some embodiments described herein. An example method 500 in FIG. 5 may be implemented using, for example, a computing device including a processor adapted to adjust or control adjustment of a tap position on a display screen of an application.

Method 500 may include one or more operations, actions, or functions as illustrated by one or more of blocks S510, S520, and/or S530. Although illustrated as discrete blocks, various blocks may be divided into additional blocks, combined into fewer blocks, supplemented with other blocks, or eliminated, depending on the particular implementation. In some further examples, the various described blocks may be implemented as a parallel process instead of a sequential process, or as a combination thereof. Method 500 may begin at block S510, “DETERMINING TAP PROBABILITIES FOR ONE OR MORE USER INTERFACE (UI) COMPONENTS OF THE APPLICATION.”

At block S510, tap probabilities for one or more UI components of the application may be determined. As depicted in FIGS. 1 to 4, probability calculator 250 may determine tap probabilities for one or more UI components of application 210 running in electronic device 110. More specifically, probability calculator 250 may record frequencies of taps on the UI components and determine the tap probabilities by division of the frequency of taps for each UI component by a sum of the frequencies of taps. Additionally, probability calculator 250 may be further configured to reflect cancellation of a tap operation on any of the UI components in determining the tap probabilities. Block S510 may be followed by block S520, “DETECTING A USER′S TAP POSITION ON AT LEAST ONE OF THE UI COMPONENTS.”

At block S520, a user's tap position on at least one of the UI components may be detected. As illustrated in FIGS. 1 to 4, tap detector 220 may detect a user's tap position on one or more of the UI components of application 210. More specifically, tap detector 220 may detect first position 440 at which the user starts a touch on the display screen and detect second position 450 at which the user ends the touch on the display screen. Further, tap detector 220 may determine a center of gravity for first and second positions 440 and 450 as the user's tap position. In some embodiments, tap detector 220 may calculate original tap gravity point 462 based on first and second positions 440 and 450. As illustrated in FIG. 4, original tap gravity point 462 may be a center of gravity of a rectangular area composed by a upper point 442 and a center point 444 of first position 440, and a upper point 452 and a center point 454 of second position 450. Block S520 may be followed by block S530, “ADJUSTING THE TAP POSITION BASED ON THE TAP PROBABILITIES.”

At block S530, the tap position may be adjusted based on the tap probabilities. As illustrated in FIGS. 1 to 4, tap position adjustor 230 may adjust the tap position based on the tap probabilities for the UI components. In some embodiments, tap position adjustor 230 may identify clickable areas 410, 420 and 430 in an area map for the current display screen that overlap at least part with first and second positions 440 and 450. Also, tap position adjustor 230 may calculate distance vectors \vec{v}ᵢ between centers of identified clickable areas 410 to 430 and original tap gravity point 462. Tap position adjustor 230 may further calculate a center of gravity \vec{G} of distance vectors \vec{v}ᵢ, where distance vectors \vec{v}ᵢ may be weighted by the tap probabilities for identified clickable areas 410 to 430. Tap position adjustor 230 may adjust the user's tap position to the center of gravity \vec{G} of distance vectors \vec{v}ᵢ.

In light of the present disclosure, for this and other methods disclosed herein, the functions and operations performed in the methods may be implemented in differing order. Furthermore, the outlined operations are only provided as examples, and some of the operations may be optional, combined into fewer operations, supplemented with other operations, or expanded into additional operations without detracting from the essence of the disclosed embodiments.

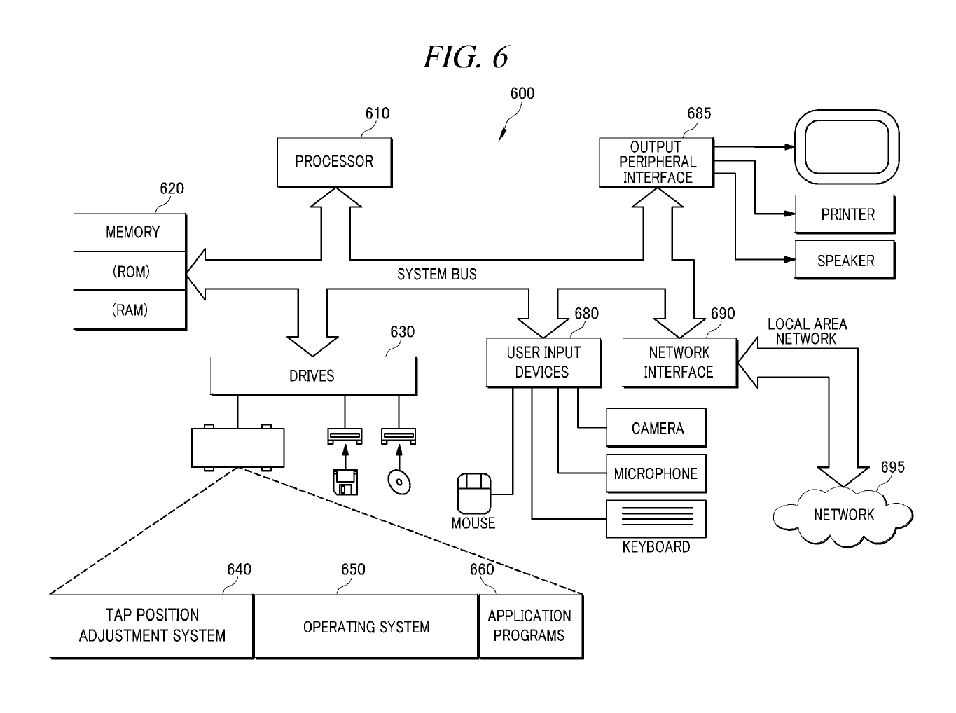

FIG. 6 shows a block diagram illustrating an example computing system that can be configured to implement method to adjust a tap position on a display screen of an application in an electronic device, arranged in accordance with at least some embodiments described herein. As depicted in FIG. 6, a computer 600 may include a processor 610, a memory 620 and one or more drives 630. Computer 600 may be implemented as a computer system, an embedded control computer, a laptop, or a server computer, a mobile device, a set-top box, a kiosk, a vehicular information system, a mobile telephone, a customized machine, or other hardware platform.

Drives 630 and their associated computer storage media may provide storage of computer readable instructions, data structures, program modules and other data for computer 600. Drives 630 may include a tap position adjustment system 640, an operating system (OS) 650, and application programs 660. Tap position adjustment system 640 may be adapted to adjust a tap position on a display screen of an application in an electronic device in such a manner as described above with respect to FIGS. 1 to 5.

Computer 600 may further include user input devices 680 through which a user may enter commands and data. Input devices can include an electronic digitizer, a camera, a microphone, a keyboard and pointing device, commonly referred to as a mouse, trackball or touch pad. Other input devices may include a joystick, game pad, satellite dish, scanner, or the like.

These and other input devices can be coupled to processor 610 through a user input interface that is coupled to a system bus, but may be coupled by other interface and bus structures, such as a parallel port, game port or a universal serial bus (USB). Computers such as computer 600 may also include other peripheral output devices such as display devices, which may be coupled through an output peripheral interface 685 or the like.

Computer 600 may operate in a networked environment using logical connections to one or more computers, such as a remote computer coupled to a network interface 690. The remote computer may be a personal computer, a server, a router, a network PC, a peer device or other common network node, and can include many or all of the elements described above relative to computer 600.

Networking environments are commonplace in offices, enterprise-wide area networks (WAN), local area networks (LAN), intranets, and the Internet. When used in a LAN or WLAN networking environment, computer 600 may be coupled to the LAN through network interface 690 or an adapter. When used in a WAN networking environment, computer 600 typically includes a modem or other means for establishing communications over the WAN, such as the Internet or a network 695. The WAN may include the Internet, the illustrated network 695, various other networks, or any combination thereof Other mechanisms of establishing a communications link, ring, mesh, bus, cloud, or network between the computers may be used.

In some embodiments, computer 600 may be coupled to a networking environment. Computer 600 may include one or more instances of a physical computer-readable storage medium or media associated with drives 630 or other storage devices. The system bus may enable processor 610 to read code and/or data to/from the computer-readable storage media. The media may represent an apparatus in the form of storage elements that are implemented using any suitable technology, including but not limited to semiconductors, magnetic materials, optical media, electrical storage, electrochemical storage, or any other such storage technology. The media may represent components associated with memory 620, whether characterized as RAM, ROM, flash, or other types of volatile or nonvolatile memory technology. The media may also represent secondary storage, whether implemented as storage drives 630 or otherwise. Hard drive implementations may be characterized as solid state, or may include rotating media storing magnetically encoded information.

Processor 610 may be constructed from any number of transistors or other circuit elements, which may individually or collectively assume any number of states. More specifically, processor 610 may operate as a state machine or finite-state machine. Such a machine may be transformed to a second machine, or specific machine by loading executable instructions. These computer-executable instructions may transform processor 610 by specifying how processor 610 transitions between states, thereby transforming the transistors or other circuit elements constituting processor 610 from a first machine to a second machine. The states of either machine may also be transformed by receiving input from user input devices 680, network interface 690, other peripherals, other interfaces, or one or more users or other actors. Either machine may also transform states, or various physical characteristics of various output devices such as printers, speakers, video displays, or otherwise.

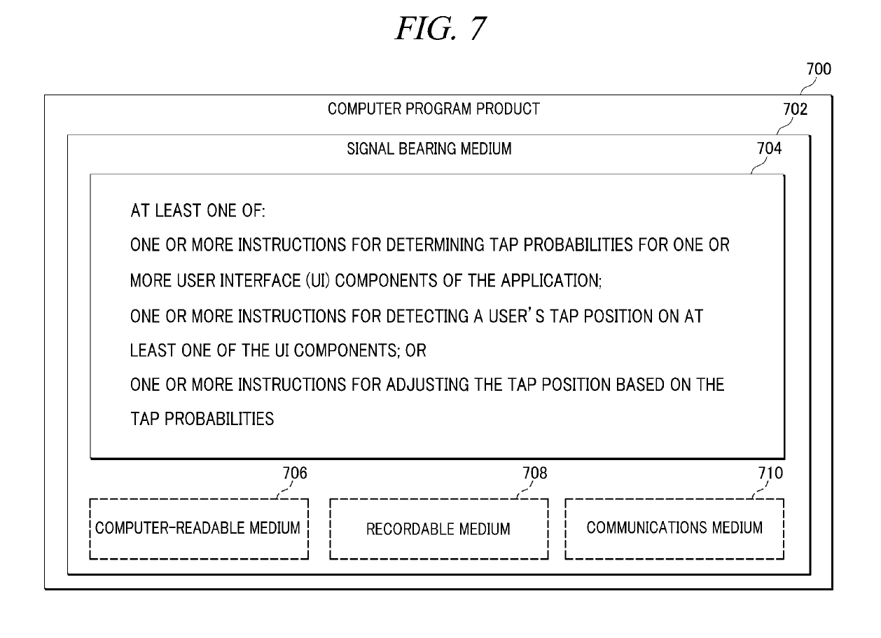

FIG. 7 illustrates computer program products that can be utilized to adjust a tap position on a display screen of an application in an electronic device, in accordance with at least some embodiments described herein. Program product 700 may include a signal bearing medium 702. Signal bearing medium 702 may include one or more instructions 704 that, in response to execution by, for example, a processor, may provide the functionality and features described above with respect to FIGS. 1 to 6. By way of example, instructions 704 may include at least one of: one or more instructions to determine tap probabilities for one or more user interface (UI) components of the application; one or more instructions to detect a user's tap position on at least one of the UI components; or one or more instructions to adjust the tap position based on the tap probabilities. Thus, for example, referring to FIGS. 1 to 4, electronic devices 110, 120 or 130 or system 100 may undertake one or more of the blocks shown in FIG. 5 in response to instructions 704.

In some implementations, signal bearing medium 702 may encompass a non-transitory computer-readable medium 706, such as, but not limited to, a hard disk drive, a Compact Disc (CD), a Digital Video Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, program product 700 may be conveyed to one or more modules of electronic devices 110, 120 or 130 or system 100 by an RF signal bearing medium 702, where the signal bearing medium 702 is conveyed by a wireless communications medium 710 (e.g., a wireless communications medium conforming with the IEEE 802.11 standard).

The present disclosure is not to be limited in terms of the particular embodiments described in this application, which are intended as illustrations of various aspects. Many modifications and variations may be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, reagents, compounds, compositions or biological systems, which can, of course, vary. The terminology used herein is for the purpose of describing particular embodiments only, and is not intended to be limiting.

The herein described subject matter sometimes illustrates different components contained within, or connected with, different other components. Such depicted architectures are merely examples, and in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

1. A method to adjust a tap position on a display screen of an application in an electronic device, the method comprising:
determining tap probabilities for one or more user interface (UI) components of the application;
detecting a user's tap position on at least one of the UI components; and
adjusting the tap position based on the determined tap probabilities.

2. The method of claim 1, wherein determining the tap probabilities comprises:
recording frequencies of taps on the one or more UI components; and
dividing each frequency of taps by a sum of the frequencies of taps.

3. The method of claim 2, wherein determining the tap probabilities further comprises recording frequencies of cancellation of the adjusting of the tap position on the at least one of the UI components.

4. The method of claim 1, wherein determining the tap probabilities comprises associating a screen state identifier (ID) of the application with the tap probabilities.

5. The method of claim 1, wherein detecting the user's tap position comprises:
detecting a first position at which the user starts touching on the display screen;
detecting a second position at which the user ends touching on the display screen; and
determining a center of gravity for the first and second positions as the user's tap position.

6. The method of claim 5, wherein adjusting the tap position comprises:
identifying one or more UI components that overlap with an area that encloses the first and second positions and having its center of gravity at the user's tap position;
calculating distance vectors between centers of the identified UI components and the tap position, the distance vectors being weighted by tap probabilities for the identified UI components; and
adjusting the tap position to a center of gravity for the distance vectors.

7. The method of claim 1, further comprising:
canceling the adjusting of the tap position in response to detection of an input to cancel the adjusting of the tap position.

8. An electronic device configured to adjust a tap position on a display screen of an application, the electronic device comprising:
a probability calculator configured to determine tap probabilities for one or more user interface (UI) components of the application;
a tap detector coupled to the probability calculator and configured to detect a user's tap position on at least one of the UI components; and
a tap position adjustor coupled to the probability calculator and to the tap detector and configured to adjust the tap position based on the determined tap probabilities.

9. The electronic device of claim 8, wherein the probability calculator is configured to record frequencies of taps on the one or more UI components and determine the tap probabilities by division of each frequency of taps by a sum of the frequencies of taps.

10. The electronic device of claim 9, wherein the probability calculator is further configured to record frequencies of cancellation of the adjustment of the tap position on the at least one of the UI components.

11. The electronic device of claim 8, wherein the probability calculator is further configured to associate a screen state identifier (ID) of the application with the tap probabilities.

12. The electronic device of claim 11, wherein the screen state ID comprises a uniform resource locator (URL).

13. The electronic device of claim 8, wherein the tap detector is configured to:
detect a first position at which the user starts a touch on the display screen;
detect a second position at which the user ends the touch on the display screen; and
determine a center of gravity for the first and second positions as the user's tap position.

14. The electronic device of claim 13, wherein the tap position adjustor is configured to:
identify one or more UI components that overlap with an area that encloses the first and second positions and having its center of gravity at the user's tap position;
calculate distance vectors between centers of the identified UI components and the tap position, the distance vectors being weighted by the tap probabilities for identified UI components; and
adjust the tap position to a center of gravity for the distance vectors.

15. The electronic device of claim 8, wherein the tap position adjustor is further configured to cancel the adjustment of the tap position in response to detection of an input to cancel the adjustment of the tap position.

16. The electronic device of claim 8, wherein the application includes a web browser and the tap position adjustor includes a JavaScript module installed in the web browser.

17. A non-transitory computer-readable storage medium which stores a program operable by the electronic device to perform the method of claim 5.

18. A system configured to adjust a tap position on a display screen of an electronic device, the system comprising:
a probability calculator configured to determine a tap probability for one or more user interface (UI) components presented on the display screen;
a tap detector coupled to the probability calculator and configured to detect a tap position on at least one of the UI components;
a tap position adjustor coupled to the probability calculator and to the tap detector and configured to adjust the tap position based on the determined tap probability and based on the detected tap position; and
an area map database (DB) coupled to the probability calculator and configured to store an area map that defines clickable areas on the display screen corresponding to the one or more UI components, wherein the area map DB is further configured to store tap probabilities in association with the clickable areas defined by the area map.

19. The system of claim 18, wherein the probability calculator is configured to record frequencies of taps on the one or more UI components and determine the tap probabilities by division of each frequency of taps by a sum of the frequencies of taps.

20. The system of claim 18, wherein the probability calculator is further configured to record frequencies of cancellation of the adjustment of the tap position on the at least one of the UI components.

21. The system of claim 18, wherein the one or more UI components are associated with an application, and wherein the probability calculator is further configured to associate a screen state identifier (ID) of the application with the tap probabilities, and wherein the area map DB is further configured to store the screen state ID in association with the clickable areas defined by the area map.

22. The system of claim 21, wherein the screen state ID comprises a uniform resource locator (URL).

23. The system of claim 18, wherein the tap detector is configured to:
detect a first position at which a user starts a touch on the display screen;
detect a second position at which the user ends the touch on the display screen; and
determine a center of gravity for the first and second positions as the tap position.

24. The system of claim 23, wherein the tap position adjustor is configured to:
identify one or more UI components that overlap with an area that encloses the first and second positions and having its center of gravity at the tap position;
calculate distance vectors between centers of the identified UI components and the tap position, the distance vectors being weighted by tap probabilities for the identified UI components; and
adjust the tap position to a center of gravity for the distance vectors.

25. The system of claim 18, wherein the tap position adjustor is further configured to cancel the adjustment of the tap position in response to detection of an input to cancel the adjustment of the tap position.

26. The system of claim 18, wherein the one or more UI components are associated with an application, and wherein the application includes a web browser and the tap position adjustor includes a JavaScript module installed in the web browser.
